(19) United States
(12) Patent Application Publication
(10) Pub. No.: US 2012/0075868 A1
(43) Pub. Date: Mar. 29, 2012

(54) LENS AND LIGHT SOURCE MODULE

(75) Inventor: HSIU-PING CHANG, Chu-Nan (TW)

(73) Assignee: FOXSEMICON INTEGRATED TECHNOLOGY, INC., Chu-Nan (TW)

(21) Appl. No.: 13/233,183

(22) Filed: Sep. 15, 2011

(30) Foreign Application Priority Data
Sep. 27, 2010 (TW) 099132510

(51) Int. Cl. F21V 5/04

(52) U.S. Cl. 362/311.1; 362/335

(57) ABSTRACT

A lens includes a light incident surface, a first light emitting surface, and a second light emitting surface. The first light emitting surface is a convex curved surface and is opposite to the light incident surface. The first light emitting surface includes a first border. The first light emitting surface and the light incident surface cooperatively form a convex lens portion with an optical axis. The second light emitting surface is located at a side of the first light emitting surface adjacent to the first border, and is a flat surface. An angle formed between the second light emitting surface and a plane perpendicular to the optical axis is larger than an angle formed between any tangent plane of the first light emitting surface passing any point on the first border and the plane perpendicular to the optical axis.

### BACKGROUND

1. Technical Field

The present disclosure relates to optical field and, particularly, to a lens and a light source module having the lens.

2. Description of Related Art

At present, the light emitted from many types of light sources, such as light emitting diodes, discharge lamps, and halogen lamps etc., has a large divergence angle. When one of these types of light sources is provided for long-distance illumination, a focus lens is generally required at the front of it to reduce the divergence angle and focus the light near the optical axis. However, in some products, such as vehicle lamp etc., the light of the light source illuminating the ground and the distant place ahead of the vehicle is useful, but the light of the light source illuminating the sky above the right ahead of the vehicle is useless. Therefore, in order to improve the efficiency of the light utilization of the light source, the light of the light source illuminating the sky above the direction ahead of the vehicle should be as less as possible.

What is needed is a lens which can ameliorate the problem of the prior art.

### BRIEF DESCRIPTION OF THE DRAWINGS

Many aspects of the present lens and light source module can be better understood with reference to the accompanying drawings. The components in the drawings are not necessarily drawn to scale, the emphasis instead being placed upon clearly illustrating the principle of the lens and light source module. In the drawings, all the views are schematic.

FIG. 1 is a schematic view of a light source module according to an exemplary embodiment.

FIG. 2 is a schematic view of the light source module of FIG. 1 viewed from another aspect.

FIG. 3 is a cross sectional view of the light source module taken along line of FIG. 1.

FIG. 4 is a cross sectional view of the light source module taken along line IV-IV of FIG. 2.

### DETAILED DESCRIPTION

Embodiments of the present disclosure will now be described in detail below, with reference to the accompanying drawings.

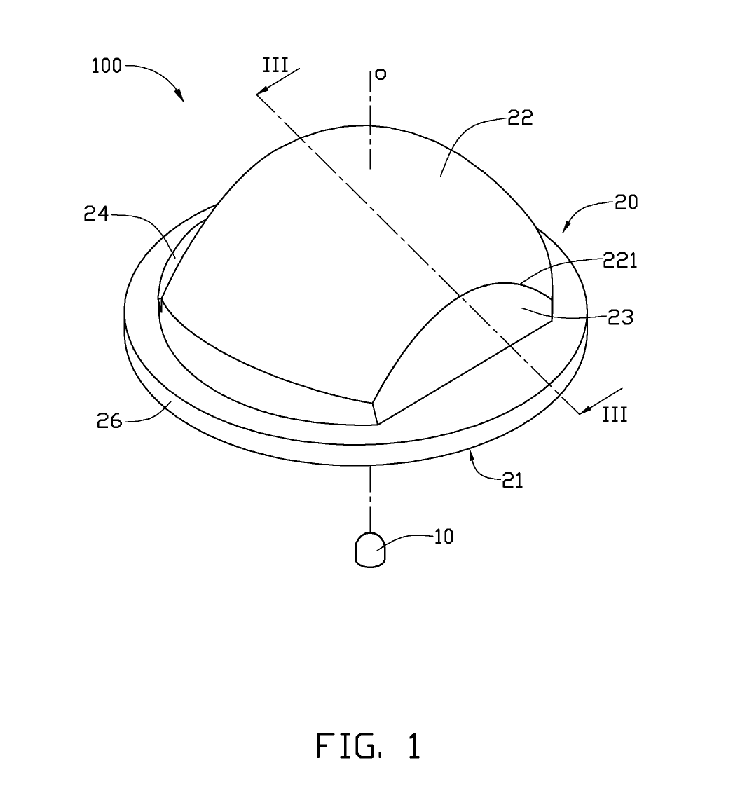

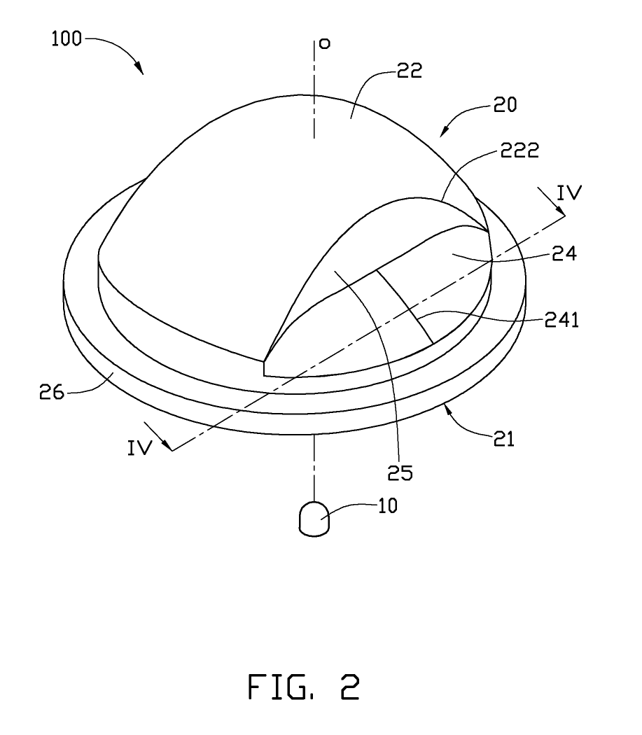

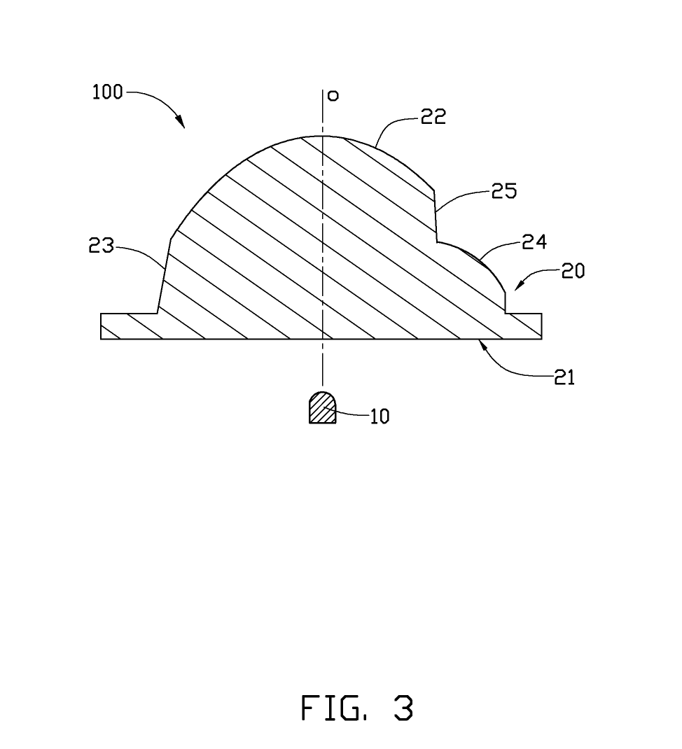

Referring to FIGS. 1 to 3, a light source module 100 according to an exemplary embodiment is shown. The light source module 100 includes a light source 10 and a lens 20. The light source 10 can be a light emitting diode, a discharge lamp, or a halogen lamp etc. The light source module 100 can be used in vehicle lamps etc.

The lens 20 includes a light incident surface 21, a first light emitting surface 22, a second light emitting surface 23, a third light emitting surface 24, and a connecting surface 25. The connecting surface 25 connects the first light emitting surface 22 to the third light emitting surface 24. The first light emitting surface 22, the second light emitting surface 23, and the third light emitting surface 24 are opposite to the light incident surface 21.

The light incident surface 21 can be a convex surface, a concave surface or a flat surface. In the present embodiment, the light incident surface 21 is a flat surface.

The first light emitting surface 22 is a convex, curved surface. The first light emitting surface 22 and the light incident surface 21 cooperatively form a convex lens portion; the convex lens portion can focus the light emitted from the light source 10. The light emitted from the light source 10 has a relatively small divergence angle after being focused by the convex lens portion, and thus can be used for long-distance illumination. When the light source module 100 is used in a vehicle lamp, the light emitted from the first light emitting surface 22 can be used for illuminating the distant place ahead of the vehicle. The convex lens portion has an optical axis O and a focal point located at a side of the lens 100 adjacent to the light incident surface 21. The light source 10 is located at the focal point; thus, the light emitted from the first light emitting surface 22 is substantially parallel light. The first light emitting surface 22 includes a first border 221 and a second border 222 opposite to the first border 221. In the present embodiment, the optical axis O is substantially perpendicular to the light incident surface 21.

The second light emitting surface 23 is located at a side of the first light emitting surface 22 adjacent to the first border 221. The second light emitting surface 23 is a flat surface. An angle formed between the second light emitting surface 23 and a plane perpendicular to the optical axis O is bigger than an angle formed between any tangent plane of the first light emitting surface 22 passing any point on the first border 221 and the plane perpendicular to the optical axis O; thus, the second light emitting surface 23 has a relatively big converging light power than that of the first light emitting surface 22, and accordingly, the angle formed between the light emitted from the second light emitting surface 23 and the optical axis O can be reduced greatly. When the light source module 100 is used in a vehicle lamp, the second light emitting surface 23 can be arranged at a side of the first light emitting surface 22 away from the ground. Because the angle formed between the light emitted from the second light emitting surface 23 and the optical axis O is reduced greatly, there will be more light emitted from the second light emitting surface 23 being used for illuminating the distant place ahead of the vehicle, and less light emitted from the second light emitting surface 23 directed to the sky.

The third light emitting surface 24 is located at a side of the first light emitting surface 22 adjacent to the second border 222. An angle formed between any tangent plane of the third light emitting surface 24 and the plane perpendicular to the optical axis O is smaller than an angle formed between any tangent plane of the first light emitting surface 22 passing any point on the second border 222 and the plane perpendicular to the optical axis O; thus, the third light emitting surface 24 has a relatively small converging light power than that of the first light emitting surface 22, and accordingly, the light emitted from the third light emitting surface 24 will deflect away from the optical axis O and from the light emitted from the first light emitting surface 22. When the light source module 100 is used in a vehicle lamp, the third light emitting surface 24 can be arranged at a side of the first light emitting surface 22 adjacent to the ground, and the light emitted from the third light emitting surface 24 can be used for short-distance illumination to illuminate the ground. The third light emitting surface 24 can be a flat surface or a curved surface. If the third light emitting surface 24 is a flat surface, the tangent plane thereof is the third light emitting surface 24 itself.

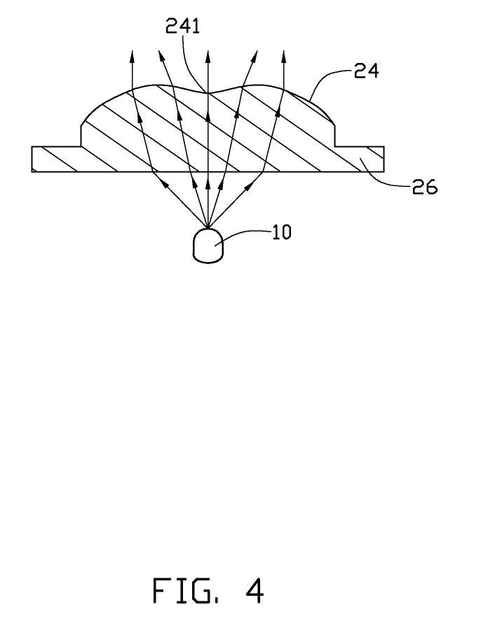

Further referring to FIG. 4, in the present embodiment, the third light emitting surface 24 is a convex, curved surface with a valley 241 therein. The valley 241 extends from a border of the third light emitting surface 24 opposite to the connecting surface 25 to the connecting surface 25. The valley 241 divides the third light emitting surface 24 into two same halves. The light incident on the two slope surfaces of the valley 241 can be deflected away from the valley 241 towards two lateral sides of the valley 241 respectively; thus, the light emitted from the third light emitting surface 24 would not concentrate at the center of the third light emitting surface 24. When the light source module 100 is used in a vehicle lamp, there will be more light emitted from the third light emitting surface 24 which can be used for illuminating the ground at two sides of the vehicle. In the present embodiment, the projection area of the third light emitting surface 24 on the plane perpendicular to the optical axis O is smaller than that of the first light emitting surface 22; thus, most of the light emitted from the light source 10 can be used for long-distance illumination.

The connecting surface 25 can reflect the light incident thereon from the light source 10 towards the first light emitting surface 22 for long-distance illumination. In the present embodiment, the light connecting surface 25 is substantially parallel to the optical axis O, and most of the light incident on the connecting surface 25 experiences a total reflection. The light connecting surface 25 can further have a light reflective film formed thereon.

In the present embodiment, the lens 20 further includes a ring-shaped protrusion 26 protruding outwardly from a circumference surface of the lens 20. The ring-shaped protrusion 26 is configured for holding the lens 20 conveniently.

While certain embodiments have been described and exemplified above, various other embodiments will be apparent to those skilled in the art from the foregoing disclosure. The disclosure is not limited to the particular embodiments described and exemplified, and the embodiments are capable of considerable variation and modification without departure from the scope and spirit of the appended claims.

What is claimed is:

1. A lens comprising:
a light incident surface;
a first light emitting surface, the first light emitting surface being a convex, curved surface and opposite to the light incident surface, the first light emitting surface comprising a first border, the first light emitting surface and the light incident surface cooperatively forming a convex lens portion with an optical axis; and
a second light emitting surface located at a side of the first light emitting surface adjacent to the first border, the second light emitting surface being a flat surface, an angle formed between the second light emitting surface and a plane perpendicular to the optical axis being larger than an angle formed between any tangent plane of the first light emitting surface passing any point on the first border and the plane perpendicular to the optical axis.

2. The lens as claimed in claim 1, wherein the light incident surface is a flat surface and is perpendicular to the optical axis.

3. The lens as claimed in claim 1, wherein the first light emitting surface further comprises a second border opposite to the first border, and the lens further comprises a third light emitting surface located at a side of the first light emitting surface adjacent to the second border, an angle formed between any tangent plane of the third light emitting surface and the plane perpendicular to the optical axis is smaller than an angle formed between any tangent plane of the first light emitting surface passing any point on the second border and the plane perpendicular to the optical axis.

4. The lens as claimed in claim 3, wherein the projection area of the third light emitting surface on the plane perpendicular to the optical axis is smaller than that of the first light emitting surface.

5. The lens as claimed in claim 3 further comprising a connecting surface connecting the first light emitting surface to the third light emitting surface.

6. The lens as claimed in claim 5, wherein the third light emitting surface is a convex, curved surface with a valley therein, the valley extends from a border of the third light emitting surface opposite to the connecting surface to the connecting surface.

7. The lens as claimed in claim 6, wherein the valley divides the third light emitting surface into two same halves.

8. The lens as claimed in claim 5, wherein the connecting surface is substantially parallel to the optical axis.

9. The lens as claimed in claim 1, wherein the lens is used in a vehicle lamp, and the second light emitting surface is arranged at a side of the first light emitting surface away from the ground.

10. The lens as claimed in claim 3, wherein the lens is used in a vehicle lamp, and the third light emitting surface is arranged at a side of the first light emitting surface adjacent to the ground.

11. A light source module comprising:
a light source; and
a lens, the lens comprising:
a light incident surface facing the light source;
a first light emitting surface, the first light emitting surface being a convex curved, surface and opposite to the light incident surface, the first light emitting surface comprising a first border, the first light emitting surface and the light incident surface cooperatively forming a convex lens portion with an optical axis;
a second light emitting surface located at a side of the first light emitting surface adjacent to the first border, the second light emitting surface being a flat surface, an angle formed between any tangent plane of the second light emitting surface and a plane perpendicular to the optical axis being bigger than an angle formed between any tangent plane of the first light emitting surface passing any point on the first border and the plane perpendicular to the optical axis.

12. The light source module as claimed in claim 11, wherein the light incident surface is a flat surface and is perpendicular to the optical axis.

13. The light source module as claimed in claim 11, wherein the first light emitting surface further comprises a second border opposite to the first border, the lens further comprises a third light emitting surface located at a side of the first light emitting surface adjacent to the second border, an angle formed between any tangent plane of the third light emitting surface and the plane perpendicular to the optical axis is smaller than an angle formed between any tangent plane of the first light emitting surface passing any point on the second border and the plane perpendicular to the optical axis.

14. The light source module as claimed in claim 13, wherein the projection area of the third light emitting surface on the plane perpendicular to the optical axis is smaller than that of the first light emitting surface.

15. The light source module as claimed in claim 13, wherein the lens further comprises a connecting surface connecting the first light emitting surface to the third light emitting surface.

16. The light source module as claimed in claim 15, wherein the third light emitting surface is a convex, curved surface with a valley therein, the valley extends from a border of the third light emitting surface opposite to the connecting surface to the connecting surface.

17. The light source module as claimed in claim 16, wherein the valley divides the third light emitting surface into two same halves.

18. The light source module as claimed in claim 15, wherein the connecting surface is substantially parallel to the optical axis.

19. The light source module as claimed in claim 11, wherein the lens is used in a vehicle lamp, and the second light emitting surface is arranged at a side of the first light emitting surface away from the ground.

20. The light source module as claimed in claim 13, wherein the lens is used in a vehicle lamp, and the third light emitting surface is arranged at a side of the first light emitting surface adjacent to the ground.
